(19) United States
(12) Patent Application Publication
(10) Pub. No.: US 2017/0233269 A1
(43) Pub. Date: Aug. 17, 2017

(54) WATER TREATMENT DEVICE

(71) Applicant: University of Utah Research Foundation, Salt Lake City, UT (US)

(72) Inventors: Swomitra Mohanty, Salt Lake City, UT (US); Manoranjan Misra, Salt Lake City, UT (US); Krista Carlson, Salt Lake City, UT (US); Jeff Huber, Salt Lake City, UT (US)

(21) Appl. No.: 15/502,111

(22) PCT Filed: Aug. 6, 2015
(86) PCT No.: PCT/US15/44035

§ 371 Date: Feb. 6, 2017

Related U.S. Application Data
(60) Provisional application No. 62/034,036, filed on Aug. 6, 2014.
(60) Provisional application No. 62/094,521, filed on Dec. 19, 2014.

(51) Int. Cl. C02F 1/72; C02F 1/00; C02F 1/467; C02F 1/32; C02F 1/50

(52) U.S. Cl. CPC C02F 1/725; C02F 1/32; C02F 1/505; C02F 1/4672; C02F 1/002; C02F 2201/3228; C02F 2303/04; C02F 2201/005; C02F 2201/009; C02F 2301/026; C02F 2305/08; C02F 2305/10; C02F 2307/02

(57) ABSTRACT

A water treatment device (100) can include a chamber (104) having an inlet (108) to receive water contaminated with pathogens and an outlet (110) to dispense treated water. The water treatment device (100) can also include a catalytic element (130) disposed in the chamber (104) to deactivate the pathogens in the water via at least one of electrocatalytic activity and photocatalytic activity. The chamber (104) and/or the catalytic element (130) can be configured to mix the water as the water flows from the inlet (108) to the outlet (110) thereby exposing the pathogens in the water to the catalytic element (130).

### RELATED APPLICATIONS

This application is related to U.S. Provisional Application No. 62/034,036, filed Aug. 6, 2014, and U.S. Provisional Application No. 62/094,521, filed Dec. 19, 2014, both of which are incorporated herein by reference.

### BACKGROUND

Residential, personal and commercial use of water typically requires safe and reliable water sources. Unfortunately, many water sources are contaminated with biological organisms such as bacteria, viruses and other pathogens. According to the Outdoor Industry Association more than 140 million Americans make outdoor recreation a priority in their daily lives. In Utah alone, 82 percent of residents (˜2.4 million people) contribute to this number. Much of this recreation is expected to require the consumption of water from natural sources which have the potential to contain bacteriological contaminants such as Escherichia coli (E. coli), harmful itself and an indicator of the presence of other disease-causing bacteria. A wide variety of water treatment options are available and can be quite effective. Such approaches include, among others, chemical treatments, ultraviolet radiation treatments, filtering systems, and the like. However, each approach has practical and commercial limitations such as material costs, aftertaste, size, weight, energy requirements, and filter replacements.

### SUMMARY

Examples of a water treatment device are disclosed herein. One example of a water treatment device includes a chamber with an inlet to receive water contaminated with pathogens and an outlet to dispense treated water. A titanium dioxide catalytic element is disposed in the chamber to kill the pathogens in the water via at least one of electrocatalytic activity and photo catalytic activity. At least one of the chamber and the catalytic element is configured to mix the water as the water flows from the inlet to the outlet thereby exposing the pathogens in the water to the catalytic element.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 illustrates a water treatment device in accordance with an example of the present disclosure including a collection canister, a partially translucent treatment chamber, and an inlet basin.

FIG. 2 illustrates a water treatment device in accordance with another example of the present disclosure including a water bladder fluidly connected to a treatment chamber.

FIG. 3 illustrates a box water treatment device having a single treatment chamber wall in accordance with yet another example of the present disclosure.

FIG. 4 illustrates a chamber of a water treatment device in accordance with an example of the present disclosure.

FIGS. 5A and 5B illustrate a reflector of a water treatment device in accordance with an example of the present disclosure.

FIG. 6 illustrates a flow-through water treatment device including an aeration stone in accordance with still another example of the present disclosure.

FIG. 7 illustrates a cylindrical water treatment device having multiple parallel treatment surfaces in accordance with a further example of the present disclosure.

FIG. 8A is a schematic of a water treatment device including a pair of electrode plates which apply a bias voltage across a electrocatalytic element in accordance with a further example of the present disclosure.

FIG. 8B is a schematic of a water treatment device including an electrode plate and contact which apply a bias voltage directly through a electrocatalytic element in accordance with a further example of the present disclosure.

FIG. 9 is a schematic of a water treatment device including an illustration of photocatalytic oxidative destruction of bacteria in accordance with one example of the present disclosure.

FIG. 10 is a schematic of a water treatment device including an assembly of a conductive plate, a channel unit, TNA, and a transparent cover in accordance with a further example of the present disclosure.

FIGS. 11A and 11B are SEM images of nanotubes annealed in a nitrogen/2% hydrogen blend on the titanium wire used in the flow-through device experiments. FIG. 11A shows a side-view of the nanotubes to display nanotube length versus diameter. FIG. 11B shows a top view of the nanotubes.

FIG. 12 is a graph of pathogen cell density as a function of time over several applied voltages.

FIG. 13 is a graph of pathogen cell density as a function of light intensity over several applied voltages.

FIG. 14 is a graph of pathogen cell density as a function of anode material over several applied voltages.

FIG. 15 is a graph of pathogen cell density as a function of saline concentration over several applied voltages.

FIG. 16 is a graph of pathogen cell density as a function of time over several applied voltages.

FIG. 17 is a graph of spectral absorbance and associated band gaps for several tested anodes.

FIG. 18 is a graph of photocurrent responses at 6 V for several tested anodes. Illumination increases the current response.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a nanotube” includes reference to one or more of such materials and reference to “subjecting” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of” For example, “at least one of A, B and C” explicitly includes only A, only B, only C, or combinations of each such as A+B only, B+C only, A+C only, and A+B+C.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Water Treatment Device

A water treatment device in accordance with the present disclosure can include a chamber having an inlet to receive water contaminated with pathogens and an outlet to dispense treated water. The water treatment device can also include a titanium dioxide catalytic element disposed in the chamber to kill the pathogens in the water via electro catalytic activity and/or photocatalytic activity. At least one of the chamber and the catalytic element can be configured to mix the water as the water flows from the inlet to the outlet thereby exposing the pathogens in the water to the photocatalytic element. Thus, in one alternative, the chamber can be defined at least in part by a wall configured to allow light to pass therethrough into the chamber. In this case, the device operates via photocatalytic activity. In another alternative, an electrical current can be applied across the catalytic element which is chosen as an electrocatalytic element. In this case, the device operates via electrocatalytic activity. In either case, the device can operate solely by photocatalytic activity or electrocatalytic activity, or may be operated contemporaneously using both electrocatalytic activity and photocatalytic activity. As described in more detail below with respect to black titanium dioxide nanotubes, it appears that electrocatalytic activity is a dominant mode of pathogen destruction, while photocatalytic activity can supplement performance.

Thus, in one aspect, the catalytic element can comprise titanium dioxide nanotubes. In one option, the water treatment device can be filled with water and exposed to sun for a short time to allow photocatalytic oxidation of pathogens to take place. Reaction of the photocatalytic element in the presence of light oxidizes the pathogens, such as E. coli, blue-green algae, protozoa and viruses, which disinfects the water, thus making it safe to drink. Similarly, application of low voltage across the catalytic element can result in electro catalytic destruction of such pathogens. Accordingly, this device can provide a low cost, simple device for point of use disinfection.

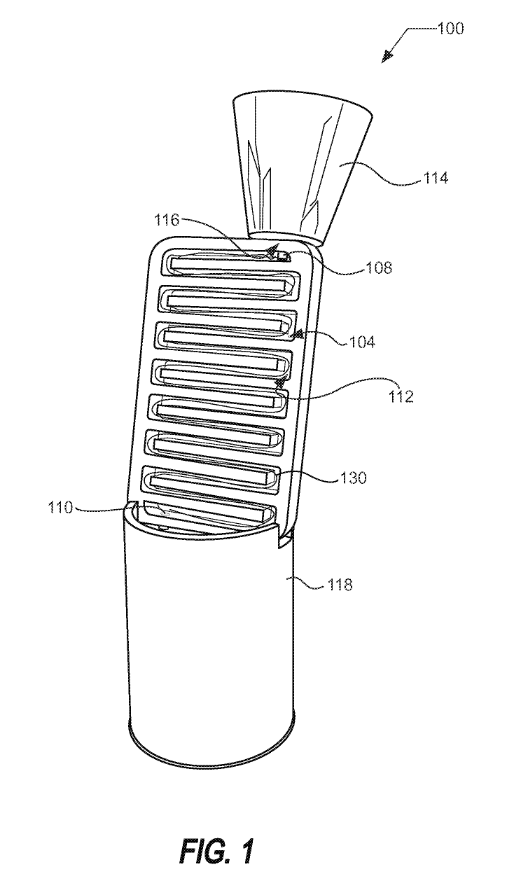

FIG. 1 illustrates a water treatment device 100 in accordance with one example of the present disclosure. The water treatment device 100 can include a chamber 104 having an inlet 108 to receive water that may be contaminated with pathogens, such as bacteria, viruses, and protozoa, and an outlet 110 to dispense treated water. The chamber 104 can be defined at least in part by a wall 112 configured to allow light to pass therethrough into the chamber 104. The wall 112 can generally be translucent and in some cases can be transparent. In one optional example, a portion of the wall can be transparent, while a separate portion can be opaque. The water treatment device 100 can also include a photocatalytic element 130 disposed in the chamber 104 to kill the pathogens in the water via photo-oxidation. In one aspect, the wall 112 can be constructed of a material (i.e., polystyrene or PDMS) to allow for a majority of low wavelengths of sunlight to reach the photocatalytic element 130, which reacts with the light to kill to the pathogens. The chamber 104 and/or the photocatalytic element 130 can be configured to mix the water as the water flows from the inlet 108 to the outlet 110 thereby exposing the pathogens in the water to the photocatalytic element 130. Thus, the chamber 104 can include passive mixing through tortuous pathways, baffles, or other stationary members which are fixed with respect to the wall.

The catalytic element can typically be fixed in position within the chamber so as to contact fluid flowing through the chamber. For example, the catalytic element can be coated on one or more interior walls of the chamber, a wire oriented within and along the chamber, on a fixed structure such as a rod or other feature, or the like. In one aspect, the catalytic element 130 can comprise a photo-active titanium dioxide material, such as an oxidative material, which reacts and creates radicals in the water when exposed to UV or natural sunlight. However, in many cases the catalytic element can also be an electrocatalytic element. In a particular aspect, the photocatalytic element 130 can comprise a titanium dioxide. For example, titanium dioxide can be in the form of nanotubes immobilized or disposed on a substrate. Titanium dioxide (TiO₂) is a non-consumable, solid-state photocatalyst that produces reactive oxygen species (ROS) when exposed to the ultraviolet portion (<387 nm) of the solar spectrum. When TiO₂ is irradiated with sunlight, electron-hole pairs are generated and react with water molecules, forming ROS, such as .OH radicals, and bacterial inactivation occurs via physical destruction of the cell membrane. Inherently immobilized TiO₂ nanotubes can be easily formed through the anodization of titanium metal. Anodically formed TiO₂ nanotube arrays (TNAs) have additional benefits of easily manipulated dimensions and better connectivity to a metal or conductive substrate. The nanotubes can typically have a diameter from about 20 to about 150 nm, and a length from about 0.5 to about 20 μm. The conductive substrate can be of any suitable configuration, such as a coil, mesh, cylinder, thin foil, etc. Non-limiting examples of conductive substrate materials can include steel, copper, aluminum, conductive polymers, metalized polymers (e.g. gold coated KAPTON and the like), and other conductive materials which exhibit suitable stability. The metal oxide can be immobilized onto a substrate by anodization, which provides a highly organized, high surface area material, or by any other suitable approach. In general, increased surface area helps to provide increased sites for radical generation, thus increasing oxidation of pathogenic materials. Increased surface area can be achieved by forming well-ordered tubes. On complex metal substrates such as titanium, electropolishing prior to anodization can improve the surface by reducing surface roughness to provide more uniform nanotube formation. This is especially helpful in mesh at locations where the titanium wires cross and the current is not uniformly distributed throughout the material. Increasing the electropolishing current up to 0.7 A improves the ability to form nanotubes at these cross sections which do not form otherwise. Generally, currents from about 0.2 to about 2 A can improve nanotubes formation. In one aspect, metal deposition can enhance the ability of the photocatalytic metal oxide array to additionally absorb more into the visible spectrum.

In one specific alternative, the titanium dioxide nanotubes can be black titanium dioxide. Black titanium dioxide can be formed by annealing titanium dioxide nanotubes in a hydrogen atmosphere, although other reducing atmosphere may be used. Although the exact composition of black titanium dioxide is not known, the material exhibits a black color, as opposed to conventional white titanium dioxide nanotubes. Furthermore, it appears that black titanium dioxide includes non-stoichiometric amounts of Ti³⁺ and a sufficient amount of defects (e.g. oxygen vacancies) to encourage additional catalytic activity. Without being bound to a specific mechanism, it appears that such defects effectively shift absorbance into the visible light range and result in improved donor density and electrical conductivity. Alternatively, the titanium dioxide can be carbon doped titanium dioxide. In one aspect, the catalytic element can have a band gap of less than about 2.5 eV.

The chamber can be provided in any suitable shape which allows for flow of fluid through the device and extensive contact with the catalytic element. Typically, the chamber can be an elongate pathway such as a conduit. However, larger chambers can be provided having partitions and can include multiple catalytic element surfaces distributed throughout the chamber.

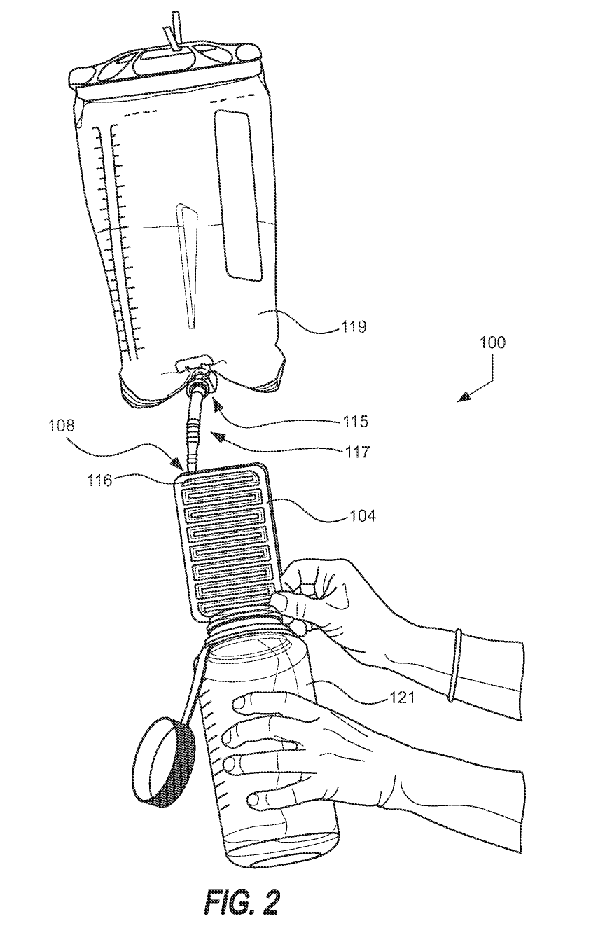

In one aspect illustrated in FIG. 1, the chamber 104 can comprise a serpentine conduit configuration which mixes the water and increases the distance the water travels through the chamber 104 within a compact device profile to improve exposure to the catalytic element 130. The catalytic element 130 can be disposed along a length of the chamber 104. As shown in FIGS. 1 and 2, the water treatment device 100 can have a thin cross-section as a conduit. As an example, the conduit largest cross-section dimension (e.g. diameter or width) can range from about 2 mm to about 10 mm, although other dimensions can be used. Similarly, the conduit can have a circular, square, rectangular, or other suitable cross-sectional shape. In another aspect, the catalytic element 130 can comprise spikes intermingled with the nanotubes to mix the water. Such spikes and turbulent mixing can physically destroy pathogens, such as by disrupting cellular membranes and walls. In yet another aspect, the photocatalytic element 130 can be disposed on a wall of the chamber 104, such as lining an interior wall of the chamber 104. This can be in addition to or as an alternative to a photocatalytic element 130 oriented in the flow path within the chamber 104.

In another aspect, the water treatment device 100 can further include an antimicrobial metal, such as Ag, Cu, Co, and/or Ni, oriented within the chamber in proximity to the catalytic element sufficient to enhance the efficacy of the catalytic element 130 in killing or otherwise deactivating pathogens. The antimicrobial metal can be deposited on separate surfaces from the photocatalytic element 130, common surfaces, or combinations thereof. In some cases, the antimicrobial metal can be co-deposited with the photocatalytic element 130 to allow for adjacent activity across the coated substrate forming a deactivation surface.

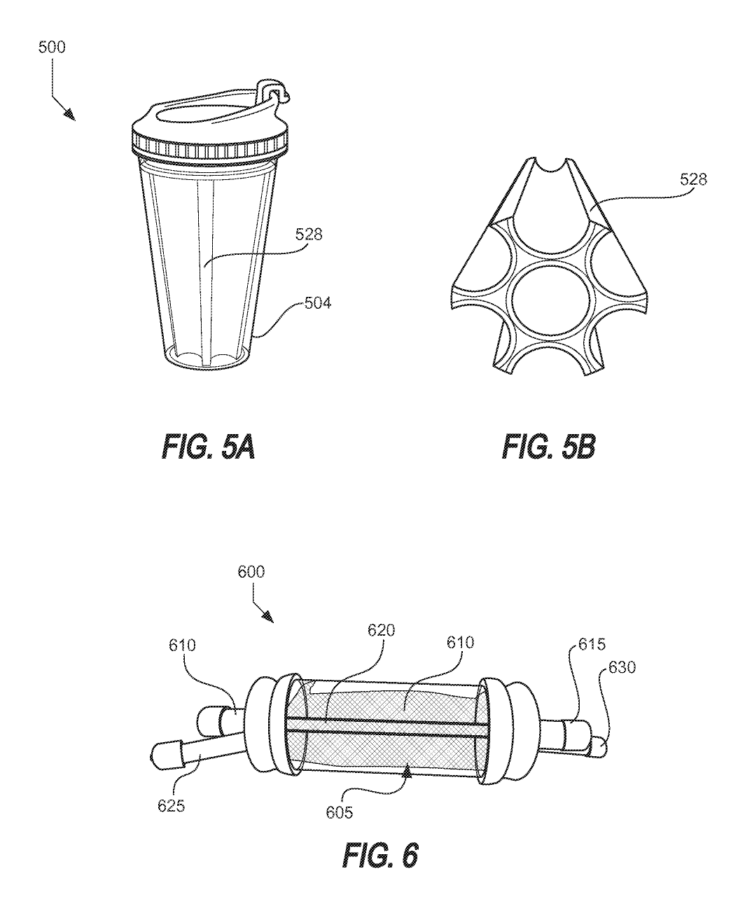

The water treatment device 100 can also include a reflector to reflect light in the chamber 104 to increase the efficiency of the device in killing pathogens. The reflector can reflect light which has passed through the chamber 104 back through the chamber 104 to trigger additional photocatalytic activity. For example, a wall 112 of the chamber 104 can comprise a reflector, which can be opposite the translucent wall that allows light into the chamber 104. Further examples of reflectors are discussed below with reference to examples shown in FIGS. 5A and 5B.

The water treatment device 100 can be a flow through device where contaminated water enters the device via the inlet 108 and treated clean or purified water exits the device via the outlet 110. Purified water can then be collected in a suitable receptacle or reservoir 118. In one aspect illustrated in FIG. 2, a control valve 115 can be associated with the outlet and/or inlet to restrict the flow of water through the chamber to increase the time that the water is exposed to the photocatalytic element, so that when the water leaves the device bacteria, viruses, and protozoa will be deactivated. Typically it is desirable to maintain a flow rate and conditions sufficient to achieve a deactivation of at least 99%, and often at least 99.99%. Similarly, control of residence time within the chamber can be obtained by variation in flow path cross-section areas. Under gravity flow, narrowing of passages can result in slower flows and longer residence time. Although in some cases, the water can flow through in a continuous manner, the valve or other flow control mechanism can be set to increase residence time within the chamber to achieve desired degree of pathogen destruction. For example, slower flow can be set to cloudy day conditions to ensure the quality of the water meets certain predetermined conditions. Furthermore, the water can flow through the chamber 104 under the influence of gravity and/or a pump.

As illustrated in FIGS. 1 and 2, the water treatment device 100 can include a reservoir interface feature to facilitate interfacing the water treatment device 100 with a supply reservoir (shown as a tapered cup reservoir 114 in FIG. 1 and a flexible bag reservoir 119 in FIG. 2) and/or a collection reservoir (shown as a canister collection reservoir 118 in FIG. 1 and a conventional water bottle 121 in FIG. 2), although any suitable reservoir such as a cup or other water receptacle can be used. FIG. 1 illustrates a tapered supply reservoir 114 with an inverted frustoconical shape having a fluid outlet 116 at the bottom which fluidly connects to an inlet 108 of the chamber 104. In this case, the chamber 104 is oriented in a serpentine configuration and includes an outlet 110 for treated water. The treated water from the outlet 110 can therefore be configured to flow into collection reservoir 118. The example illustrated in FIG. 1 shows water entering the inlet 108 via a frustoconical supply reservoir 114, however other configurations are contemplated.

In one aspect, the reservoir interface feature can be configured to attach the water treatment device to a bladder, bottle, or other suitable inlet and/or outlet container or reservoir. The reservoir interface feature can comprise a threaded coupling feature, a snap-on coupling feature, or any other suitable coupling feature for attaching the water treatment device to a container or reservoir. For example, the reservoir interface feature can have threading on the bottom that will align with a common water bottle. Thus, the water treatment device can be attached to a clean water collection reservoir to receive contaminated water from a “dirty” water supply reservoir or source and slowly filter the water through the device to provide clean water that drains directly into bottle 121 as shown for example in FIG. 2.

In another optional aspect, the water treatment device can be integrated into a lid or cap for a bottle or container. In a particular aspect, the reservoir interface feature can comprise an adapter that couples with a port of the outlet. In another aspect, the collection reservoir can be configured to receive or interface with the water treatment device. The water treatment device can therefore temporarily interface with the collection reservoir to provide treated water to the collection reservoir, after which, the water can be consumed directly from the collection reservoir.

In another example, as illustrated in FIG. 2, contaminated water can be contained in a contaminated water supply reservoir 119, fed to water treatment device 100, and then drained into a clean collection reservoir 121 for use. An optional control valve 115 can be used to control the input rate of contaminated water into the device 100. The supply water can exit the contaminated water supply reservoir 119 and pass through the control valve 115 into the inlet 108 of the device 100 via a conduit 117 at a fluid outlet 116 thereof.

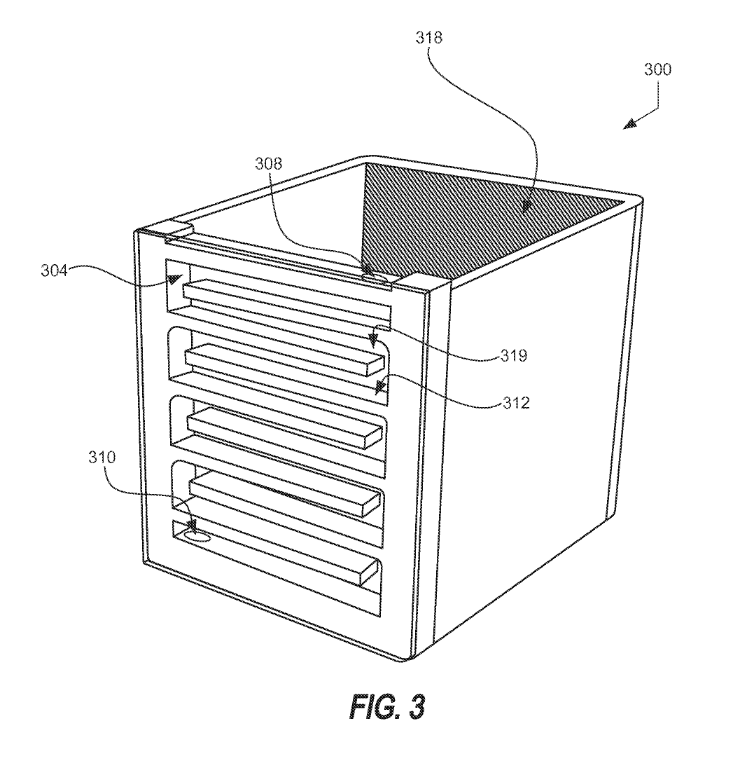

FIG. 3 illustrates a water treatment device 300 in accordance with another example of the present disclosure. In this case, the water treatment device 300 can be integrated with or in the form of a cup or other water containment vessel for end use. For example, an outlet 310 of the chamber 304 can be in fluid communication with a collection reservoir 318 to contain the treated water and the collection reservoir 318 can be defined at least in part by a common wall 319 of the chamber 304. In the example illustrated, the chamber 304 is located on only one lateral side of the reservoir 318. However, it should be recognized that the chamber 304 can be disposed or located on any suitable side of the collection reservoir 318, such as about all lateral sides of the reservoir 118. In such as case, the chamber 304 can spiral around the outside of the reservoir 318. Regardless, the common wall 319 segregates the treatment chamber 304 from the collection reservoir 318 which retains treated water.

In another optional aspect, a water treatment device can be removably attached to a side of a collection reservoir. In this case, the water treatment device can be configured as a cassette that is inserted into a slot or receptacle of the reservoir for providing treated water to the reservoir. The cassette can then be removed when not in use or replaced as needed.

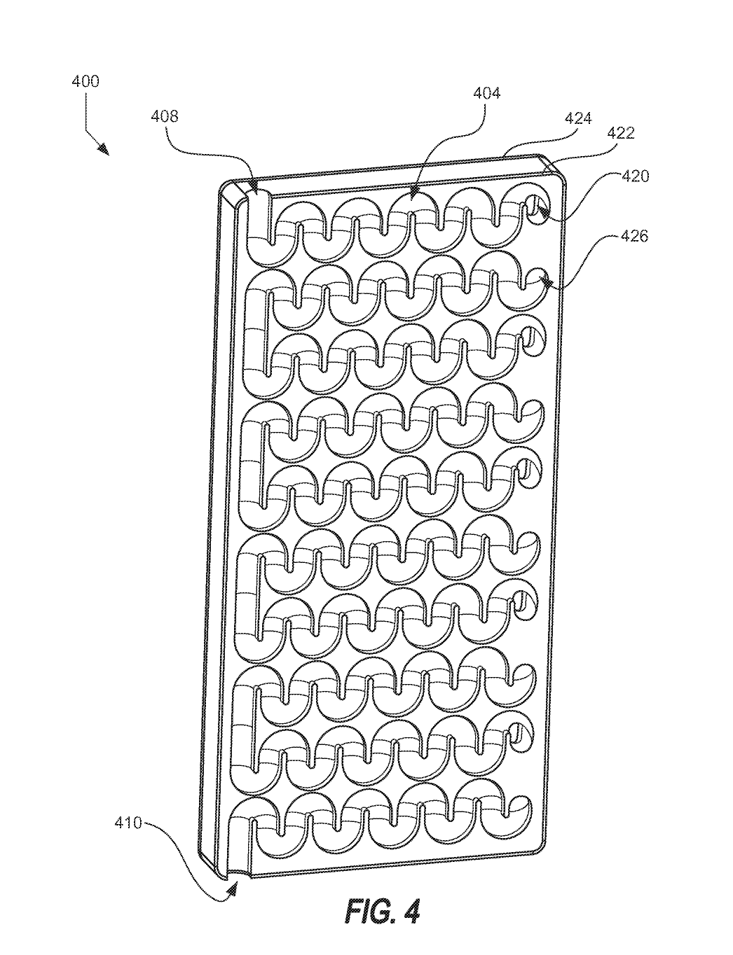

FIG. 4 illustrates a serpentine double-layered chamber 404 of a water treatment device 400 in accordance with an example of the present disclosure. The chamber 404 illustrated is configured to provide improved mixing of the water as the water passes through the chamber 404. In one aspect, the chamber 404 can include a flow disruption feature to mix the water, such as a protrusion (i.e., a bump or panel), a recess, and/or a textured surface. For example, the chamber 404 can have a roughened, bumpy or corrugated surface to aid in providing turbulent water flow. As illustrated, the chamber 404 can also be serpentine (left-to-right) and undulating (up-and-down) to provide a non-linear disruptive flow path which creates additional turbulent mixing. In another aspect, the chamber 404 can be configured to direct flow in three dimensions to mix the water. For example, from inlet 408 at a top of the device 400, water can flow from left to right in a serpentine manner for flow in two orthogonal dimensions. At a far right, the water can flow through the device 400 (into the page) to the other side of the device for flow in a third orthogonal dimension. This is shown in FIG. 4 at an interfacing channel 420 from the front side 422 to the back side 424 of the chamber 404. On the back side 424 (hidden from view), the water can flow from right to left and back from left to right where the water can then pass through the device 400 to the front side 422, for example at another interfacing channel 426, and so on until the water has exited the device 400 at the outlet 410. In this configuration, two sets of serpentine channels are oriented side-by-side and fluidly connected such that fluid flows alternately through both sides. This configuration can be described as a three-dimensional serpentine configuration. Such a configuration can promote turbulent flow of water and chaotic mixing to increase the exposure of the pathogens in the water to the photocatalytic element (not shown) in the chamber, thus improving the effectiveness of the water treatment device.

FIGS. 5A and 5B illustrate aspects of another example of a water treatment device 500. In this case, the water treatment device 500 can include a reflector 528 that can include parabolic surfaces to reflect light in the chamber 504 to increase the effectiveness of the light irradiation. The reflector 528 can be configured as a cylindrical concentrator and can be made out of any suitable reflective material or coated with titanium dioxide nanotubes to further enhance the efficacy. The parabolic reflectors can be oriented outwards from a common center axis, or oriented on one side of the chamber 504 to reflect light back into the chamber 504. Regardless, the parabolic reflectors can be oriented to increase exposure to light within a given volume. The water treatment device 500 illustrated can be self-circulating, which provides shear force and mixing by inverting the bottle until disinfection has been achieved.

In any one of the disclosed embodiments, optional additional particulate filters can be fluidly connected prior to the chamber in order to reduce concentration of particulate contaminants. Excessive particulate concentration may increase water opacity and/or decrease effective contact of pathogens with the catalytic element. Accordingly, such particulate filters can utilize mesh sizes of 0.5 mm or smaller, and in some cases no greater than 200 μm.

FIG. 6 illustrates aspects of yet another example of a water treatment device 600. In this case, the water treatment device 600 can include a photocatalytic element 610 comprising a mesh configuration. Specifically, the photocatalytic element 610 can be coated on a mesh support substrate. The water treatment device 600 can include a treatment chamber 605 having a water inlet 610 and a water outlet 615. In yet another optional alternative, this water treatment device 600 is configured to provide aeration to generate additional forced mixing and shear forces to enhance biocide effects. These shear forces can be introduced through manual mechanism or power generated using a pumping mechanism. A manual mechanism can include an air piston which is hand-actuated and coupled to an aerator. Alternatively, an air pump can be connected to a power source and an aerator. Typically, the bubbling from aeration is more effective with smaller bubbles, thus, in one aspect, an air stone 620 can be used to provide aeration. Accordingly, an air inlet 625 and air outlet 630 can be fluidly connected to the chamber 605.

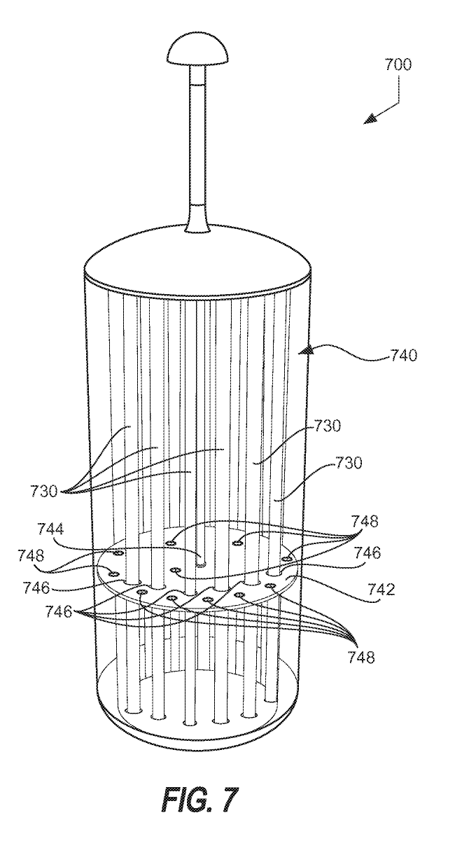

FIG. 7 illustrates aspects of still another example of a water treatment device 700. In this case, the water treatment device can include a photo catalytic element 730 that comprises a chamber 740 having a cylindrical configuration. The photocatalytic element 730 can be coated on a plurality of rods vertically oriented parallel to one another within treatment chamber 740. A plunger 742, which can also optionally include a photocatalytic material coated thereon, can be configured to move vertically as operatively connected to a stem 744 within the chamber 740 to move slidably about the photocatalytic element 730, thus causing mixing of the water and creating bubbles to promote contact of the pathogens in the water with the photocatalytic material. The plunger 742 can include holes or openings 746 corresponding to the plurality of photocatalytic elements 730 such that the photocatalytic elements 730 pass through the plunger 742 as the plunger 742 moves along a length of the photocatalytic elements 730. In one aspect, the plunger 742 can include additional holes or openings 748 to promote mixing and bubble formation.

Although the water treatment device is operable using solely exposure to UV light, a bias voltage can also be used to increase biocidal activity in conjunction or alone. As such, it appears that biocidal activity can be achieved solely with application of a bias voltage. Thus, in some embodiments, the treatment chamber walls can be entirely opaque. Regardless, the bias voltage can be applied directly to the catalytic element and/or opposing plates to produce an electric field across the catalytic element.

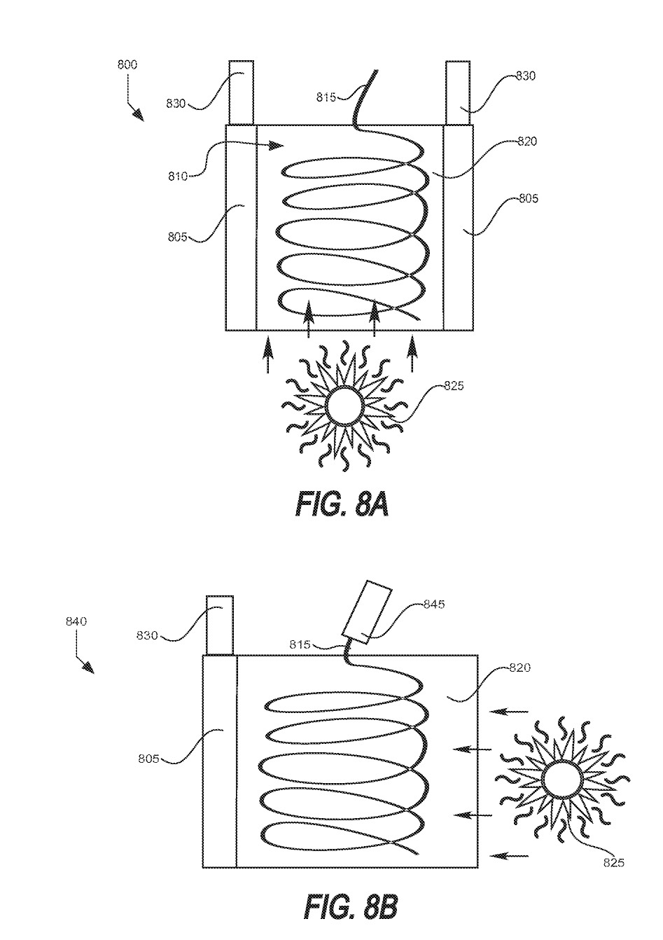

FIG. 8A illustrates a device 800 with a pair of conductive plates 805 on opposing sides of a treatment chamber 810 which contains a photocatalytic element 815, the chamber being bounded on a front side thereof by a UV transparent face plate 820. The face plate 820 allows light to pass therethrough, for example, by irradiation from the sun 825 as indicated in FIGS. 8A and 8B by arrows pointing toward and through the face plate 820. Each of the conductive plates 805 includes a contact 830 adapted to receive an applied bias voltage. The photocatalytic element 130 can optionally include a contact adapted to receive an applied bias voltage from a suitable voltage source (e.g. battery, capacitor, etc). In one alternative, the catalytic element 815 can be oriented within a serpentine chamber such as those illustrated in FIGS. 1-4. In another option, FIG. 8B illustrates a device 840 having a single electrode plate 805 and a photocatalytic element 815 which is directly connected to a power source of the bias voltage via contact 845. In this case, the photocatalytic element 815 can be conductive and optionally coated on a conductive wire or other conductive substrate. In each of these two aspects, the photocatalytic element 815 is exposed to an applied electric field (e.g. directly or indirectly). In one aspect, the photocatalytic element can be formed or coated on a conductive substrate which is electrically connected to a power source. Connectivity is especially important in a photoelectrocatalytic (PEC) cell, for example, where an anodic bias is applied to a Ti substrate of a TNA for improved efficiency. Driving photogenerated electrons away from the surface reduces electron-hole pair recombination, increasing the time and concentration of holes that can react with water molecules to form radicals or directly oxidize bacteria. Such driving force can also prevent the TNA from becoming negatively charged, eliminating any electrostatic repulsion that the negatively charged bacteria would have to overcome.

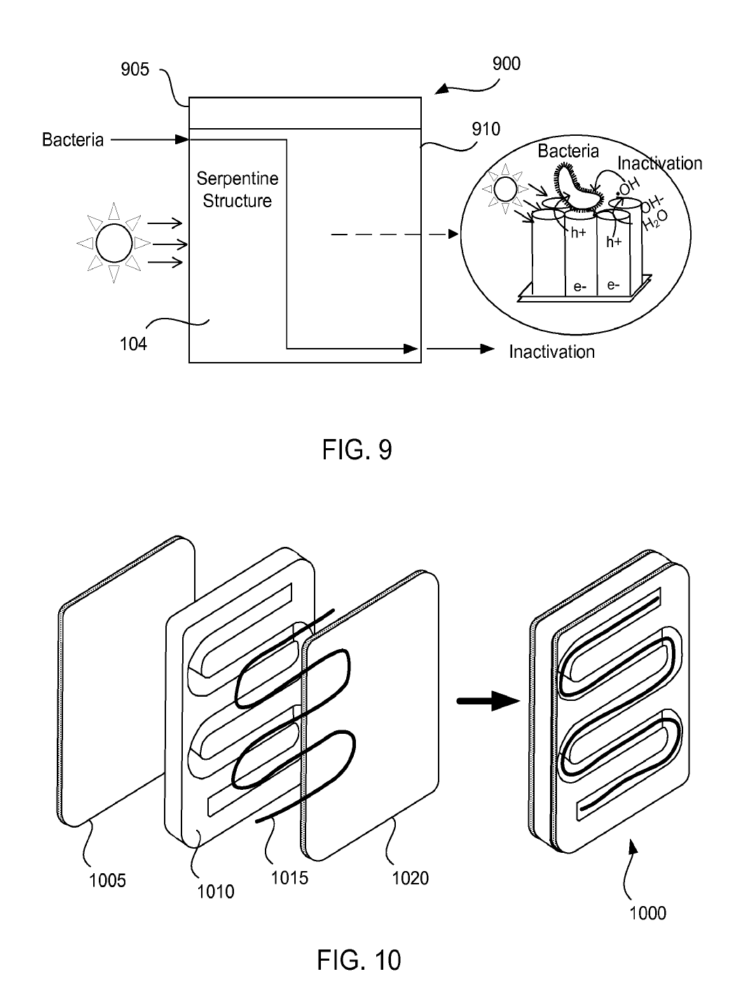

FIG. 9 is a schematic of a photoelectrocatalytic water treatment device 900 which illustrates a serpentine structure which is exposed to sunlight under an applied bias via a cathode plate 905. As described in more detail below, radicals are produced by photocatalytic mechanisms. Bacteria and other organisms which are exposed to such radicals experience oxidative stress which results in inactivation.

FIG. 10 illustrates one example of a photoelectrocatalytic water treatment device 1000 disassembled and assembled as a paneled composite assembly. Specifically, a conductive plate 1005 can be oriented adjacent a channel unit 1010. The photocatalytic element 1015 can be oriented along a length of channels within the channel unit 1010. A UV transparent cover 1020 can also be oriented adjacent the channel unit 1010 opposite the conductive plate 1005 to form an enclosed treatment chamber. Fluid inlets and outlets can be oriented at opposing ends of the channels to allow water to be treated while continuously flowing through the device as described in connection with other embodiments. Similarly, optional control valves can be used to control inflow and/or outflow of fluid. Manual control valves can allow a user to choose treatment and use times, although automated valves could be used.

The conductive plate 1005 can be formed of any suitable conductive material. Non-limiting examples of suitable conductive materials include stainless steel, conductive polymers, and the like. The conductive plate 1005 can be a solid plate or can be mounted on a support substrate with a conductive element shaped to align with walls of the channels.

The channel unit 1010 can be formed using any suitable technique. For example, a solid piece of material can be cut or etched to form the channels. Alternatively, the channel unit 1010 can be printed using 3D printing to reduce waste material. The channel unit 1010 can often be made of a non-conductive material such as, but not limited to, polylactic acid (PLA), polystyrene, food-safe plastics, and the like, although conductive materials can also be used.

The transparent windows 1020 can be formed of any material which is transparent to UV irradiation. Non-limiting examples of suitable materials can include polystyrene, glass, polycarbonate, or other UV transparent food-safe material.

Accordingly, the device can also include a power source operatively connected to the contacts so as to provide the bias voltage for enhanced biocidal activity. Although other power sources may be suitable, non-limiting examples can include a battery, a solar cell, or other DC source. The power source can be adapted such that the bias voltage is from 1 V to 60 V, in some cases from about 2 V to 15V, in other cases from 2 V to 10 V, and in some cases from 2.5 V to 7 V. As a general guideline, application of a voltage greater than about 5V can result in biocidal activity even in the absence of any light irradiation.

Optional static mixing members can be included along treatment channels in order to increase shear on cells and to enhance destruction of cell walls. Static mixing members can include baffles or other protrusions along the channel walls which create localized shear forces on passing cells.

Over time, the catalytic elements may exhibit decreased catalytic activity. Therefore, an optional sensor can be used to detect pathogen levels. For example, a blue dye can be entrained that becomes clear when the water is fully treated. A user can replace the device when the time it takes for the dye to become colorless is longer than desired for the water to be disinfected. Other sensor mechanisms can include, but are not limited to, electrochemical sensors made of metal-oxide electrodes that perform differential pulse voltammetry, cyclic voltammetry, potentiostatic voltmeter, or potentiodynamic voltammetry, to electronically detect pathogen levels. In addition colorimetric sensors can be integrated that change color based on the presence of the pathogen. Other sensors that can be included are optical or absorbance methods, and portable flow cytometry, and portable resistive pulse sensing techniques. Alternatively, or in addition, the device can also be replaced after a certain volume of water is processed.

Depending on impurities or other operating conditions, the catalytic elements may become physically obscured (i.e. coated with debris) or chemically deactivated. Thus, in some cases it can be desirable to replace the treatment chamber. Alternatively, the catalytic elements may be regenerated by flushing with a suitable fluid. In the case of physical debris, a solution of acid, surfactant or other compounds can loosen or otherwise facilitate detachment of debris from the catalytic elements. For example, the catalytic surfaces can be acid cleaned and optionally anodized to reactivate or otherwise improve performance of the catalytic elements. End users may optionally treat the chamber in alcohol to improve performance. Generally, as long as the water going through the chamber is not excessively turbid or is not stored in the dark after not properly being rinsed, the catalytic elements should perform for an extended or indefinite period of time. In one aspect, an acid solution containing HF acid can be used to recycle the substrate. In another example aspect, a solution of 90% ethanol can used as an antibacterial step. Other methods for refreshing the substrate can include, but are not limited to, concentrated UV light and applying a voltage on the wires to remove debris and other material.

In some cases it can be desirable to include a particulate filter which removes larger particulates prior to treatment with the catalytic elements. For example, certain water sources may include moss, dirt or other debris which can clog the chamber. Accordingly, in one aspect, the device can further include a particulate filter fluidly connected prior to the inlet of the treatment chamber.

In yet a further aspect, the water treatment device can be configured as a handheld portable device. Such portable devices can be particularly suitable for emergency drinking water, backpacking, and the like. Portable devices can typically weigh less than about 1 lb and have a largest outer dimension of about 20 cm, and often less than 12 cm.

### Example 1

A flow through device combining photocatalysis and electroporation was developed for bacterial biocide of simulated and natural waters. The device provided complete biocide of contaminated waters with throughputs of 50 ml/min. The device included titanium dioxide nanotubes arrays in which a bias of up to 6 V was applied without noticeable water splitting. Light intensity, applied voltage and background electrolyte type and concentration were all found to impact performance of the device. Complete biocide occurred in 15 seconds in the device irradiated at 25 mW with an applied voltage of 4 V in a 100 ppm NaCl solution. Biocide in natural water was inhibited by the presence of other inorganic ions which are commonly found in natural water. Accordingly, a higher voltage of 6 V was used to reach 100% efficiency because of these ions. To simulate natural scenarios in which a point of use application might be employed, testing was conducted in a natural environment using source water from Emigration Creek in Salt Lake City, Utah. Parameters such as contact time, lighting conditions, applied voltage and NaCl concentrations were investigated.

The flow through device 900, shown in FIG. 9, contains PLA channels with a stainless steel backplate 905 and a UV transparent polystyrene faceplate 910. The anodically formed photocatalytic TNAs wire was placed within the PLA channel, with a portion exposed to allow for connection to the power supply. Thus, in some cases a separate contact is not needed so that a conductive catalytic coated substrate can be directly connected to a power source. The titanium wire (ESPI metals, 99.7% Ti) was cut to size, ultrasonically cleaned in a 50/50 vol % methanol/isopropanol solution and then chemically polished in an acetic acid solution. Anodization was performed at 30 V for 60 minutes in a fluorinated ethylene glycol solution using mechanical stirring and a Pt gauze (52 mesh) cathode. After anodization, samples were rinsed with methanol and ultrasonicated in deionized (DI) water. The amorphously formed nanotubes (NTs) were crystallized at 500° C. for 2 hours in a reducing atmosphere.

E. coli W3110 was selected as the model bacteria to evaluate PC and PEC/E inactivation efficiencies under varying parameters and conditions. Bacterial strains were taken from refrigerated stock and subcultured in Luria Bertani (LB) Agar at 40° C. for approximately 3 hours while shaking at 200 rpm. The culture was ready when the absorbance indicated the bacteria was at the peak of the logarithmic growth phase, or an absorbance of ˜1.2. Cell densities used throughout this study were ˜8.0×10³ colony forming units per milliliter (CFU·ml⁻¹), several orders of magnitude higher than those typically observed in nature.

Disinfection was conducted in the TNA containing flow through device 900 using a solar simulator with AM 1.5. Sunny days were simulated with 100 mW·cm⁻² and cloudy day conditions were approximated by 25 mW/cm². Incident UV irradiation on the surface of the flow reactor was typically ˜ 1/10^{th} of its respective full light spectrum intensity: ˜3 mW/cm² and ˜10 mW/cm² for 25 mW/cm² and 100 mW/cm², respectively. Contaminated water was gravity fed through the flow reactor at ˜50 mL/m. For electric field assisted experiments, an anodic potential between 1 V and 6 V was applied to the TNA and a stainless steel plate was used as the cathode. A flow reactor was also tested with an aluminum anode to examine the effects of electroporation without a photo catalytic material. Control experiments were performed with the various anodes in the absence of UV irradiation. Additionally, blank devices without an anode material were also run as controls. Bacteria samples were well mixed before being poured through the device to avoid settling.

The enumeration of E. coli concentrations before and after treatment was carried out by plating 50 μl aliquots onto LB agar. The LB agar plates were incubated overnight at 37° C. and colonies were visually identified and counted. Testing was performed in triplicate and an average of the results were taken as data points. Error bars are representative of the standard deviation between individual samples in each test. A paired t-test was performed to determine statistical significance at a 95% confidence level.

Emigration Creek at Rotary Glen Park was used as a sample location for natural water disinfection as it represents a realistic source water that one might drink from while recreating in nature. Samples collected from this location were treated under natural sunlight using voltage conditions that were found to be favorable in the laboratory controlled E. coli experiments. In-situ field data collected consisted of light intensity (total and UV), temperature, oxidation-reduction potential (ORP), conductivity and pH. The water was not turbid and contained little debris so filtering was not performed. Sodium chloride was added to the system at concentrations of 10, 100 and 1000 ppm to simulate levels examined in the lab. Samples were brought to ChemTech-Ford Laboratories for enumerated total coliform.

Natural water samples were also brought back to the laboratory for testing under controlled sunlight and with the addition of NaCl. The sample water was filtered through a 0.2 gm filter to ensure no bacteria remained in solution. Laboratory grade E. coli W3110 was then diluted into the natural water and run through the flow device under 100 mW cm⁻². The test was also run with a spiked NaCl concentration of 100 ppm. After the gravity fed samples were treated at a flow rate of ˜50 ml·m⁻¹ the samples were brought to ChemTech-Ford Laboratories for enumerated total coliform and E. coli analysis.

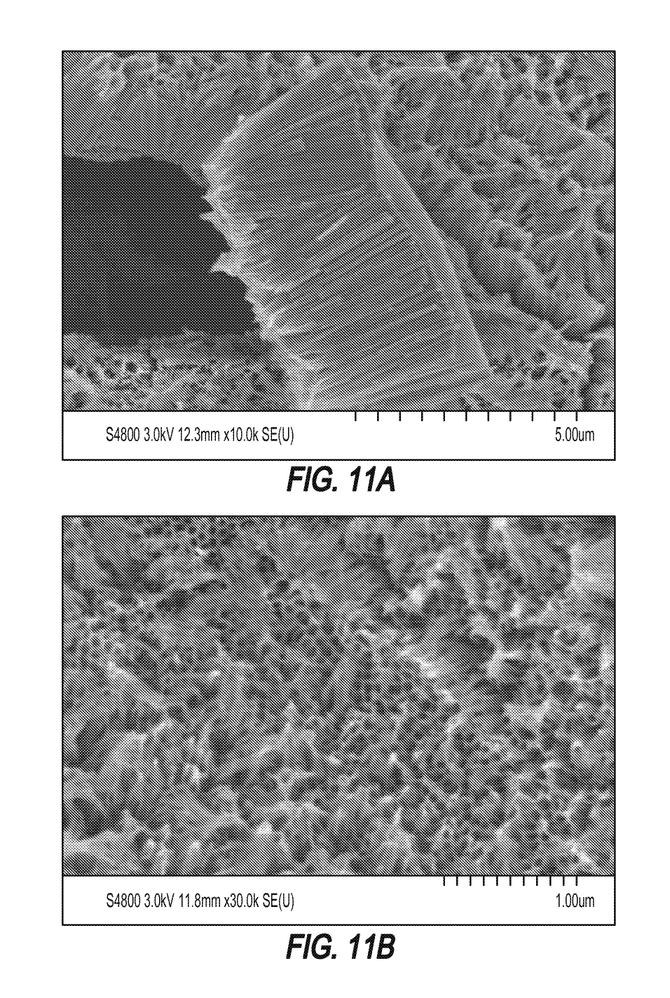

The appearance of the TNAs is shown in FIGS. 11A and 11B. Titanium wires exhibited well defined tubes and/or nanograss, thin tubes that collapse and bundle when removed from the anodization solution. Average nanotube dimensions were 59 nm in diameter and 3.5 gm in length.

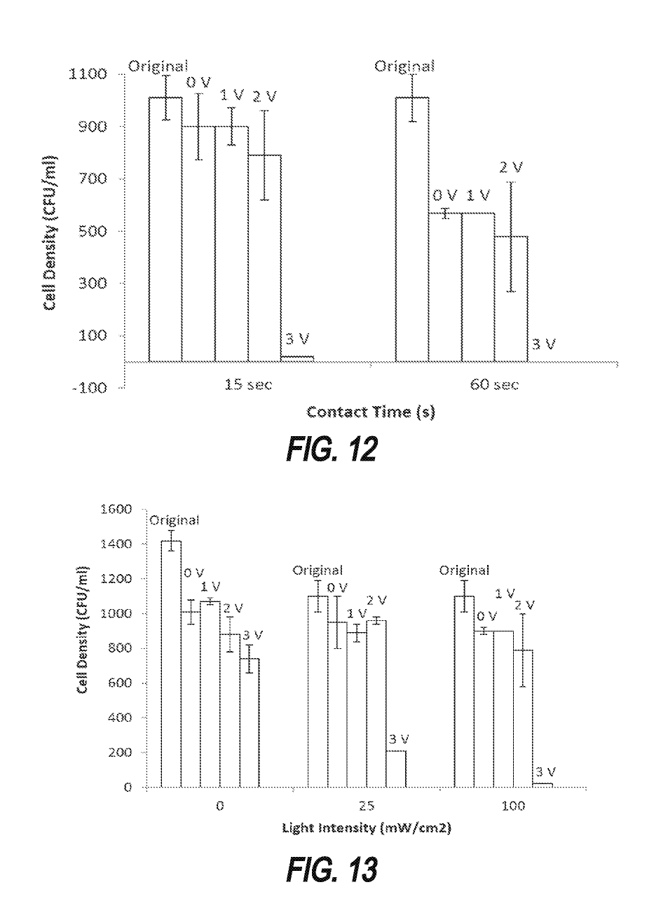

Inactivation results for different contact times within the reactor are shown in FIG. 12. A contact time of 60 seconds under static conditions in the flow reactor showed a reduction of several hundred active bacteria between 0 V and 2 V, dropping to 479 CFU/mL at 2 V from the original concentration of 1010 CFU/mL, but no statistical difference between these applied voltages was seen. At 4 V, no bacteria were detected. A contact time of 15 seconds under dynamic conditions expressed a similar trend, but exhibiting higher values, about double of those observed for the 60 second treatment, dropping to 790 CFU/mL at 2 V with no statistical difference between 0 V and 2 V. At 3 V, no bacteria were detected. The blank devices run as controls exhibited no significant reduction or difference in active bacteria between experiments. Subsequent testing was conducted with a 15 second contact time under dynamic conditions, as this rate is closer to desirable product flow rates. Complete biocide was observed at voltages ≧3 V.

Reactor efficiency data under different irradiation conditions is shown in FIG. 13. No statistical difference between the 0, 25 and 100 mW·cm⁻² conditions was observed until 3 V, where bacteria concentrations dropped to 790, 210 and 20 CFU·ml⁻¹, respectively. The testing device was designed to incorporate a large overpotential, so that water splitting was not visually observed at 6 V with the TNA anode.

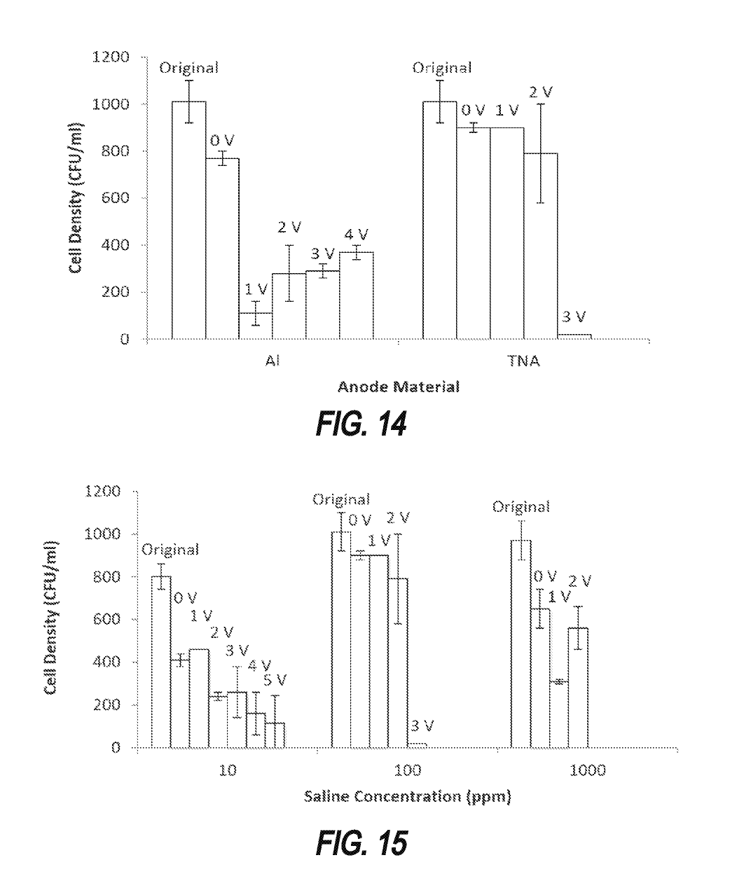

The difference between the TNA and the Al anode on bacterial inactivation is shown in FIG. 14. Initially the Al outperforms the TNA until 3 V. Up until this point, the Al anode is able to inactivate ˜70 percent of the bacteria. At 3 V, the TNA becomes drastically more effective, while the Al still does not show any statistical difference in its values. The Al consistently displays a significantly higher current than the TNA anode.

Inactivation with different NaCl concentration additions to the device are shown in FIG. 15. A concentration of 10 ppm NaCl showed ˜50 percent reduction at 1 V, but did not show a statistical difference in reduction between 1 V and 5 V. Little reduction in active bacteria was observed between 1 V and 2 V for the 100 ppm and 1000 ppm NaCl additions, but complete inactivation was achieved at 5 V and 4 V, respectively. Typical salt concentrations found in natural waters where experiments took place have been found to be approximately 50 ppm.

Chemical analysis of the water collected at Emigration Creek is shown in Table 1. Experiments similar to those run in the laboratory were conducted under natural conditions at Emigration Creek. Table 1 shows the results of the experiments conducted under the conditions above.

TABLE 1
Environmental and water conditions and chemistry
in Emigration Creek at Rotary Glen Park

| Parameter | | |
|---|---|---|
| Flow Rate | 50 | ml/min |
| Light Intensity | 100 | mW/cm2 |
| UV | 12.6 | mW/cm2 |
| pH | 8.02 | |
| Conductivity | 1186 | uS |
| ORP | 397 | mV |
| Temperature | 12.2° C. | |
| Sulfate | 152 | ppm |
| Nitrate | 0.4 | ppm |
| Nitrite | <0.1 | ppm |
| Chloride | 1 | ppm |

Total coliform as well as E. coli were enumerated as CFU·100 ml⁻¹. Total coliform was shown to reduce from a starting concentration of 2300 CFU 100·ml⁻¹ to 52 CFU·100 ml⁻¹ at 6 V and with a spiked concentration of 100 ppm NaCl. The E. coli count also showed a reduction from an initial count of 20 CFU·100 ml⁻¹ to 2 CFU·100 ml⁻¹ at 6 V with a spiked concentration of 100 ppm NaCl.

The results from experiments conducted in the laboratory with natural water samples are shown in Table 2. Complete biocide was seen from an initial concentration of 2100 CFU 100·ml⁻¹ using an applied bias of 6 V.

TABLE 2
Biocide results from device testing Emigration
Creek water under natural settings.

| | Total Coliform |
|---|---|
| Condition | (CFU/100 ml) |
| Original | 2300 |
| 0 V, 0 ppm NaCl | >2400 |
| 0 V, 10 ppm | >2400 |
| 0 V, 100 ppm | >2400 |
| 4 V, 0 ppm NaCl | 1100 |
| 4 V, 10 ppm NaCl | 1300 |
| 4 V, 100 ppm NaCl | 300 |
| 5 V, 0 ppm NaCl | 1000 |
| 5 V, 10 ppm NaCl | 400 |
| 5 V, 100 ppm | 650 |
| 6 V, 0 ppm NaCl | 490 |
| 6 V, 10 ppm | 50 |
| 6 V, 100 ppm | 52 |

Table 3 shows the results of experimentation on natural water spiked with E. coli in the laboratory.

TABLE 3
Biocide results from device testing
Emigration Creek water under simulated
solar irradiation of 100 mW/cm².

| Condition | Total Coliform (CFU/100 ml) |
|---|---|
| Original | 2100 |
| Blank | 2600 |
| 4 V | 1700 |
| 6 V | 0 |

The experiment without the NaCl addition was able to achieve complete biocide at 6 V from an initial concentration of 150,000 CFU 100·ml⁻¹ and the experiment with the NaCl addition was also able to achieve complete biocide at 6 V with an initial concentration of 100,000 CFU·100 ml⁻¹. The current at 4 V in the natural water was ˜1.5 times the current in the simulated water. The current at 6 V in the natural water was comparable to the current at 4 V using the Al anode in the simulated water.

TABLE 4
Biocide results from filtered Emigration Creek
water, spiked with W3110 E. Coli and irradiated
under simulated solar intensity of 100 mW/cm².

| Conditions | E. Coli (CFU/100 ml) |
|---|---|
| Original | 150000 |
| Blank | 29000 |
| 4 V | >2400 |
| 6 V | 0 |
| Original—100 ppm | 100000 |
| Blank—100 ppm | 98000 |
| 4 V—100 ppm | >2400 |
| 6 V—100 ppm | 0 |

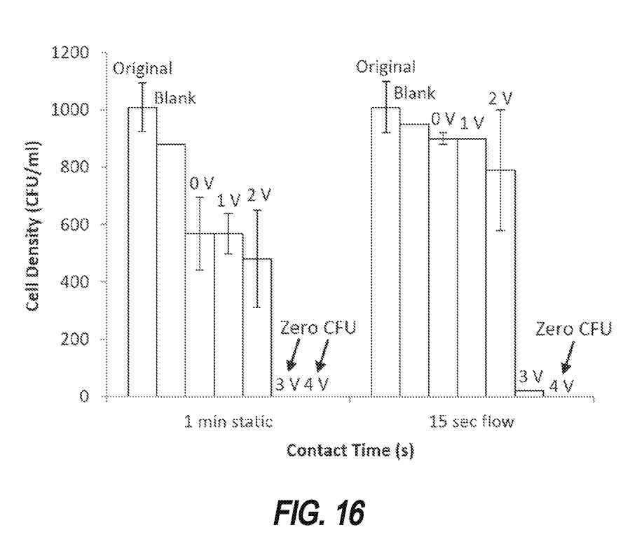

FIG. 16 outlines biocide results under 100 mW/cm² irradiation and an electric field range of 500 to 2000 V/m (i.e. 1 to 4 V over a 2 mm gap). Relatively fast (i.e. 1 min and 15 seconds) results were achieved at bias voltages of 3 V and 4 V.

The environment inside the reactor during treatment is unfavorable for pathogens due to both PC generation of radicals and the applied electric field. Irradiation of the TNA with light <387 nm causes bound electrons to excite into the conduction band, leaving behind a hole situated in the valence band, Eq. 1.

TiO₂+hν(>Eg)→TiO₂+e⁻(CB)+h⁺(VB) (1)

These holes are then free to react with adsorbed ⁻OH and H₂O, generating hydroxyl radicals (.OH). The reactions, summarized in Eqs. 2 and 3, are theorized to be of great importance in biocide as .OH has the highest oxidation power of aqueous and elemental radical species that can be generated during photocatalysis.

TiO₂(h⁺)+⁻OH_{ads}→TiO₂+.OH (2)

TiO₂(h⁺)+H₂O_{ads}→TiO₂+.OH_{ads}+H⁺ (3)

During PEC, electrons are driven into the circuit via the nanotubes and Ti substrate to reduce their recombination rate with holes. This extended time period allows holes to directly participate in the oxidation reaction with the bacteria which is especially important as holes have a higher relative oxidation power (2.35) than .OH (2.05). Scheme 1 shows a depiction of the oxidation process through direct (h interaction) or indirect processes (i.e. .OH).

However, from the data collected, it was observed that PC and PEC (<2 V) alone does not inactivate the bacteria at flow rates that are necessary for this type of device. Gram-negative bacteria, such as E. coli, produces the enzyme superoxide dismutase (SOD) in response to oxidative stress. This enzyme can transform radicals into hydrogen peroxide (H₂O₂) and molecular oxygen via reactions Eq. 4. Bacteria then produce catalase which breaks down intracellular H₂O₂ into water and oxygen (Eq. 5).

2O₂.⁻+2H⁺SOD→O₂+H₂O₂ (4)

H₂O₂+H₂O₂catalase→O₂+2H₂O (5)

To make the device more effective without increasing overall size or contact time with the TNA, a voltage above what is required for PEC was applied to the system to induce electroporation. In electroporation, high voltage electric fields temporarily destabilize the lipid bilayer and proteins composing the cell membrane. This reversible breakdown results in permeation of the cell membrane and unregulated permeation of molecules. Pore size is a function of electric field intensity and duration within the field. Field strength for reversible breakdown is in the range of 3-24 kV·cm⁻¹ for bacteria cells. Long time periods at these field strengths and/or fields above this range can lead to irreversible mechanical destruction of the membrane.

In pulsed electric field systems, pulses of high voltage reach between 20-80 kV·cm⁻¹. These complex and energy intensive systems are not feasible for portable device operation; however, as the device described in this paper does not rely solely on electric fields for cell lysing, the power requirements can be substantially reduced. At 4 V, the device is calculated to have an electric field of ˜0.2 kV·cm⁻¹. Although this field strength is below field strengths reported for bacterial electroporation (˜2.2 kV·cm⁻¹), it is proposed that just enough permeation is occurring to allow radical penetration into the cell. Complete biocide can occur then at low field strengths as radicals can directly attack cell components without having to oxidize the cell defense enzymes or breakdown the membrane. Increasing the irradiation intensity on the system shows little effect <3 V as the channels are too wide and the flow is too fast for PC generated radicals to be effective on either own. However, at 3 V, enough photo generated radicals are present to significantly increase biocide. Interestingly, at 4 V, the field strength becomes high enough to cause biocide without UV stimulation; however, having the semiconductor material is beneficial as shown in the Al anode experiments. After an initial drop in cell density, the Al anode showed similar values between 1 V and 4 V. The semiconductor materials plays a role in that under a high enough anodic bias, electron hole pairs can be generated without irradiation.

Increasing the chloride concentration was observed to decrease the voltage at which biocide was observed. Chloride and dihalide ions increase bioactivity in PEC as the photogenerated holes now have a longer lifetime and can ionize chlorine through the following reactions (Eqs. 7 and 8):

h⁺(VB)+Cl⁻→Cl. (7)

Cl.+Cl⁻→Cl₂.⁻ (8)

The chemistry of natural surface waters vary greatly depending on a number of factors such as location, temperature, human or ecological influences, etc. The natural water treated in this study contained inorganic ions not present in the synthesized water. The photolytic disinfection rate was reduced when sulfate and nitrate ions were present in solution. Sulfates appear to block active sites via adsorption to TiO₂ surfaces, while nitrates absorb UV light resulting in the production of hydroxyl radicals. The drop in current with time for the natural water is thought to be caused by the deposition of sulfates on the TiO₂ surface. The simulated sunlight experiments are thought to have been more efficient than the natural sunlight experiments due to the columnated light concentrated directly on the surface of the disinfection device.

Inactivation of E. coli in a flow reactor device using a combination of photocatalysis and electroporation occurred in both simulated and natural water. A higher voltage was needed in the natural water containing additional inorganic and organic ions. For each of the parameters evaluated PEC/E showed to be more effective for bactericidal efficiency than the PC experiments. The optimal applied bias for complete biocide was >3 V. Increasing the NaCl concentration in solution improved the efficiency of the device, but should be limited to 100 ppm to avoid poor taste in water. Increasing the light intensity did not show to be a significant contributor to the efficacy of the device as irradiation was not found to be necessary for complete biocide at an applied bias of >3 V. The ORP of the reactor may be brought up to 600 mV where complete disinfection occurs.

### Example 2

A water treatment device similar to the one illustrated in FIG. 1 was constructed and tested. Titanium foils (ESPI metals, 99.9% purity) were cut to 1.2 cm×2 cm strips and mechanically polished. For coil anodes, sections of titanium wire (ESPI metals, 99.7% purity, 0.35 mm dia.) were cut and wound to a 2 mm radius, generating coils with 5 turns/cm. The anodes were ultrasonically cleaned and electropolished (25 V, 1 min) in a glacial acetic acid: perchloric acid solution. TiO₂ nanotube arrays (TNAs) were prepared on the titanium substrates via anodization (30 V, 1 h) in an acidic ethylene glycol solution using a platinum mesh cathode. Crystallization of the amorphous as-formed tubes was achieved by annealing the TNAs at 500° C. for 2 hours in air (air-TNA), nitrogen (N2-TNA) or 2% hydrogen with a nitrogen balance (H2-TNA).

The tested devices have flow rates of 50 ml/min, with a different number of channels for 15 s and 25 s retention times. The devices were taken to Emigration Creek, located in Salt Lake City, Utah, on a sunny day where the average irradiation was 100 mW/cm². Creek water was collected and run through the device at several different voltages. Sample volumes of were taken for Total Coliform and Escherichia Coli (E. Coli) enumeration before and after treatment. Results were reported as organisms per 100 ml of water (org/100 ml).

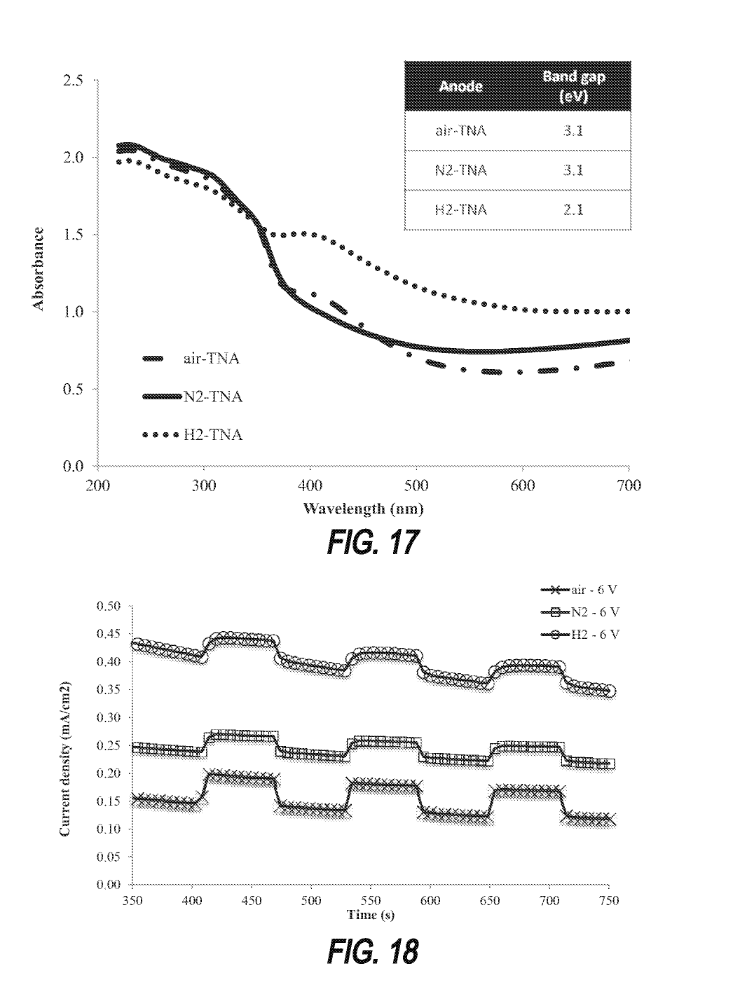

FIG. 17 illustrates spectral absorbance curves and associated band gap for various TNA anodes annealed in air, nitrogen and hydrogen, respectively. Hydrogen annealed TNA anodes resulted in black titanium dioxide. The black color is a result of higher absorbance in the visible light range than exhibited by either inert or oxygen atmospheres. Corresponding band gaps show markedly lower band gap for the black titanium dioxide which results in higher electrocatalytic activity.

FIG. 18 shows the transient photocurrent responses of the various anodes investigated over several on-off cycles of intermittent irradiation with an applied bias voltage of 6 V. All of the anodes exhibited anodic photocurrent in the absence of an applied bias. Notably, with an applied bias of 6 V, the hydrogen annealed anode exhibits ˜50% greater dark current. Table 5 illustrates radical formation data for the tested anodes at several bias voltages. The presence of radicals was confirmed using DPD (N, N-diethyl-p-phenylenediamine) free chlorine reagent (HACH Permachem Reagents). The DPD colorimetric method is typically used to detect free and total chlorine in water; however, this reagent will react with any radical species present. When radicals are present, a magenta species develops, and the measured optical absorbance at 510 nm provides a semi-quantitative radical concentration. Higher absorbance corresponds to higher levels of radical formation.

TABLE 5
Radical formation for various anodes for 5 minutes.

| | Radical Formation (Abs.) | | |
|---|---|---|---|
| Anode | 1 V | 3 V | 6 V |
| Ti | 0.001 | 0.001 | 0.001 |
| air-TNA | 0.002 | 0.001 | 0.005 |
| N2-TNA | 0.003 | 0.001 | 0.097 |
| H2-TNA | 0.006 | 0.497 | 0.682 |

Pathogens can be exposed to radicals for time periods based on the oxidation-reduction potential (ORP) of the environment. Suitable disinfection time can also be pathogen dependent as certain types of bacteria are more effective at producing enzymes to counteract oxidative stress, inhibiting radicals from damaging the cell membrane. However, disinfection time and applied bias can be adjusted in order to achieve a 6-log removal from a starting influent concentration of 10⁷/100 ml. Table 6 shows bacterial inactivation performance at various conditions.

TABLE 6
Bacterial inactivation data

| | Illumination | Total Coliform | E. Coli |
|---|---|---|---|
| Condition | (mW/cm²) | (CFU/100 ml) | (org/100 ml) |
| Original | NA | >2400 | 165 |
| 0 V | 100 | >2400 | 110 |
| 0 V | 0 | >2400 | 130 |
| 6 V | 100 | 0 | 0 |
| 6 V | 0 | 0 | 0 |

Thus, after 25 seconds in the device, complete bacterial inactivation was achieved at 6 V, even under no illumination.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A water treatment device, comprising:
a chamber having an inlet to receive water contaminated with pathogens and an outlet to dispense treated water; and
a titanium dioxide catalytic element disposed in the chamber to kill the pathogens in the water via at least one of electrocatalytic activity and photocatalytic activity,
wherein at least one of the chamber and the catalytic element is configured to mix the water as the water flows from the inlet to the outlet thereby exposing the pathogens in the water to the catalytic element.

2. The water treatment device of claim 1, wherein the chamber comprises a serpentine configuration.

3. The water treatment device of claim 1, wherein the chamber is configured to direct flow in three dimensions to mix the water.

4. The water treatment device of claim 1, wherein the chamber comprises a flow disruption feature to mix the water.

5. The water treatment device of claim 4, wherein the flow disruption feature comprises at least one of a protrusion, a recess, and a textured surface.

6. The water treatment device of claim 1, wherein the catalytic element comprises at least one of a cylindrical configuration, a coil configuration, a mesh configuration, and a chamber wall coating.

7. The water treatment device of claim 1, wherein the catalytic element is disposed in a fixed position within the chamber.

8. The water treatment device of claim 1, wherein the catalytic element comprises titanium dioxide nanotubes.

9. The water treatment device of claim 8, wherein the titanium dioxide nanotubes are formed of black titanium dioxide.

10. The water treatment device of claim 8, wherein the catalytic element comprises spikes intermingled with the nanotubes to mix the water.

11. The water treatment device of claim 1, wherein the catalytic element is a photocatalytic element configured to react in the presence of UV light to kill the pathogens via photocatalytic activity, and the chamber is defined at least in part by a wall configured to allow light to pass therethrough into the chamber.

12. The water treatment device of claim 11, further comprising a reflector to reflect light in the chamber.

13. The water treatment device of claim 1, further comprising an anti-microbial metal.

14. The water treatment device of claim 13, wherein the anti-microbial metal comprises at least one of Ag, Cu, Co, and Ni.

15. The water treatment device of claim 1, further comprising a reservoir in fluid communication with the outlet to contain the treated water, wherein the reservoir is defined at least in part by a wall of the chamber.

16. The water treatment device of claim 1, further comprising a reservoir interface feature to facilitate interfacing the water treatment device with a reservoir, wherein the treated water from the outlet is configured to flow into the reservoir.

17. The water treatment device of claim 1, further comprising a control valve associated with the outlet to restrict the flow of water through the chamber to increase the time that the water is exposed to the catalytic element.

18. The water treatment device of claim 1, wherein the water flows through the chamber under the influence of at least one of gravity and a pump.

19. The water treatment device of claim 1, wherein the catalytic element is an electrocatalytic element which is electrically conductive and the device further comprises contacts electrically associated with the device such that a bias voltage can be applied across the catalytic element to kill the pathogens via electrocatalytic activity.

20. The water treatment device of claim 19, further comprising a power source operatively connected to the contacts so as to provide the bias voltage.

21. The water treatment device of claim 20, wherein the power source is at least one of a battery and a solar cell.

22. The water treatment device of claim 19, wherein the power source is adapted such that the bias voltage is from 1 V to 60 V.

23. The water treatment device of claim 22, wherein the bias voltage is from 2.5 V to 7 V.

24. The water treatment device of claim 19, wherein the contacts are electrically connected to the electrocatalytic element.

25. The water treatment device of claim 19, wherein the catalytic element is also a photocatalytic element and the chamber is defined at least in part by a wall configured to allow light to pass therethrough into the chamber to kill the pathogens via electrocatalytic activity and photocatalytic activity.
